(19) United States
(12) Patent Application Publication
(10) Pub. No.: US 2014/0085944 A1
(43) Pub. Date: Mar. 27, 2014

(54) DC-AC POWER CONVERTING APPARATUS AND SOLAR POWER SUPPLYING APPARATUS INCLUDING THE SAME

(71) Applicants: SAMSUNG ELECTRO-MECHANICS CO., LTD., Suwon, Gyunggi-do (KR); Research & Business Foundation Sungkyunkwan University, Suwon, Gyunggi-do (KR)

(72) Inventors: Tae Won LEE, Suwon, (KR); Min Ho HEO, Suwon (KR); Jun Gu KIM, Suwon (KR); Chung Yuen WON, Gwacheon (KR); Yong Hyok JI, Suwon (KR); Young Ho KIM, Seoul (KR); Doo Young SONG, Suwon (KR); Gyu Dong KIM, Seosan (KR)

(73) Assignees: Research & Business Foundation Sungkyunkwan University, Suwon (KR); SAMSUNG ELECTRO-MECHANICS CO., LTD., Suwon (KR)

(21) Appl. No.: 13/770,938

(22) Filed: Feb. 19, 2013

(30) Foreign Application Priority Data
Sep. 27, 2012 (KR) 10-2012-0107731

(51) Int. Cl. H02M 7/537

(52) U.S. Cl. CPC H02M 7/537
USPC 363/37

(57) ABSTRACT

There are provided a DC-AC power converting apparatus including no capacitor or a small capacity capacitor for removing a ripple in an input terminal thereof by charging or discharging power according to a difference between output power and instantaneous system power of a photovoltaic cell, and a solar power supplying apparatus including the same, the DC-AC power converting apparatus including a DC-AC power converting unit converting DC power into AC power, and a charging and discharging unit charging surplus power induced when a level of the DC power is higher than that of the AC power and discharging the charged power when the level of the DC power is lower than that of the AC power.

### CROSS-REFERENCE TO RELATED APPLICATIONS

This application claims the priority of Korean Patent Application No. 10-2012-0107731 filed on Sep. 27, 2012, in the Korean Intellectual Property Office, the disclosure of which is incorporated herein by reference.

### BACKGROUND OF THE INVENTION

1. Field of the Invention

The present invention relates to a direct current (DC)-alternating current (AC) power converting apparatus in which a converter and an inverter are integrated into a single power converting circuit and a solar power supply apparatus including the same.

2. Description of the Related Art

As environmental pollution, global warming, and the like, are gradually becoming more serious due to the use of fossil fuels, and gases such as carbon dioxide, NOx, SOx, and the like, created thereby, have steadily increased in the severity of their impact on the environment from the end of 20th century, demand for and development of new renewable energy sources have increased. In particular, the demand t and necessity of technological developments in the area of renewable energy have suddenly increased due to liability for reductions in greenhouse gas emissions, based on the Kyoto Protocol and the sudden increase in crude oil prices. Currently, problems with limitations on energy resources are directly connected with national security issues and therefore, the willingness to address reductions in carbon dioxide emissions and technologies therefor have been recognized as contributing to national competitiveness.

In various new renewable energy sources, in spite of the disadvantage of low efficiency, the development of a photovoltaic (PV) cell (solar cell) serving as an inexhaustible source of clean energy and according with domestic semiconductor technologies, has been continuously expanded in a domestic market in recent times. In the case of foreign countries, a solar power supplying apparatus using the photovoltaic (PV) cell has been commercialized under the leadership of Japan and Germany, based on technical skills and financial ability accumulated over a long period of time.

Generally, solar power supplying apparatuses include a converter that converts DC power from the photovoltaic (PV) cell into DC power having a predetermined level and an inverter that converts the DC power from the converter into commercial AC power, as described in the following Citation List. In the converter and the inverter, power conversion efficiency has become the most important issue.

To this end, the solar power supplying apparatus has been provided with a DC-AC power converting apparatus in which the converter and the inverter are integrated into a single power converting circuit. In this case, the DC-AC power converting apparatus has a high-capacity electrolytic capacitor disposed in the input terminal thereof so as to reduce a low frequency ripple in the input terminal caused due to a variation in output voltage, but a size of a circuit may be increased due to an amount of capacity of the electrolytic capacitor and a lifespan of the solar power supplying apparatus that needs to be used for years to decades may be shortened due to the electrolytic capacitor.

### RELATED ART DOCUMENT

(Patent Document 1) Korean Patent Laid-Open Publication No. 10-2009-0133036

### SUMMARY OF THE INVENTION

An aspect of the present invention provides a direct current (DC)-alternating current (AC) power converting apparatus including no capacitor or a small capacity capacitor for removing a ripple in an input terminal thereof by charging or discharging power according to a difference between output power and instantaneous system power of a photovoltaic cell to reduce the ripple occurring in the capacitor disposed in the input terminal, and a solar power supplying apparatus including the same.

According to an aspect of the present invention, there is provided a direct current (DC)-alternating current (AC) power converting apparatus, including: a DC-AC power converting unit converting DC power into AC power; and a charging and discharging unit charging surplus power induced when a level of the DC power is higher than that of the AC power and discharging the charged power when the level of the DC power is lower than that of the AC power.

The charging and discharging unit may include: a charging switch performing a switching operation to provide a charging path for the induced surplus power, when the level of the DC power is higher than that of the AC power; a discharging switch performing a switching operation to provide a discharging path for the charged power, when the level of the DC power is lower than that of the AC power; and a capacitor unit charging or discharging power according to the switching operations of the charging switch and the discharging switch.

The charging switch and the discharging switch may be alternately switched on and switched off with respect to each other.

The charging and discharging unit may further include: an inductor unit LC resonating with the capacitor unit to provide a soft switching operation of the charging switch and the discharging switch.

The DC-AC power converting unit may include: a converter switching the DC power to convert the DC power into first DC power having a preset frequency; and an inverter switching the first DC power to convert the first DC power into the AC power.

The converter may include: a switch switching the DC power; a transformer including a primary winding receiving the power switched by the switch, a secondary winding forming a preset turns ratio with the primary winding and outputting power having a voltage level according to the preset turns ratio, and a tertiary winding receiving the surplus power induced when the level of the DC power is higher than that of AC power, to transfer the induced surplus power to the charging and discharging unit, while receiving the power discharged from the charging and discharging unit when the level of the DC power is lower than that of the AC power; an output switch switching the power output from the secondary winding of the transformer; an output diode providing an output path for the power switched by the output switch; and an output capacitor stabilizing the power from the output diode.

The inverter may include: an inverter circuit switching the first DC power to convert the first DC power into the AC power; and a stabilization circuit stabilizing the converted AC power from the inverter circuit.

The DC-AC power converting apparatus may further include: an input capacitor reducing a ripple in an input terminal generated due to a variation in the AC power.

The first DC power may be unfolding power having a rectified form in which a sine wave signal is rectified.

The DC-AC power converting apparatus may further include: a control unit controlling power switching of the DC-AC power converting unit and charging and discharging switching of the charging and discharging unit.

The control unit may include: a converter control unit providing a power switching signal having a duty set according to a comparison between voltage of a maximum power point based on voltage and current information regarding the DC power and a preset carrier and an output switching signal having a duty set according to the AC power; and a charging and discharging control unit providing a charging and discharging switching signal having a duty set according to the voltage information of the maximum power point.

The converter control unit may generate the power switching signal by multiplying a preset first gain by the voltage of the maximum power point, and generate the output switching signal by adding the first DC power to the power switching signal.

When the power switching signal has a turn off level, the charging and discharging switching signal may have a turn on level.

According to another aspect of the present invention, there is provided a solar power supplying apparatus, including: a photovoltaic cell collecting solar light to convert the light into DC power; a DC-AC power converting unit converting the DC power from the photovoltaic cell into AC power; and a charging and discharging unit charging surplus power induced when a level of the DC power is higher than that of the AC power and discharging the charged power when the level of the DC power is lower than that of the AC power.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration diagram of a general solar power generation system;

FIG. 2 is a diagram illustrating waveform graphs of output power and instantaneous system power of a photovoltaic cell;

FIG. 3 is a schematic circuit diagram of a DC-AC power converting apparatus according to an embodiment of the present invention;

FIG. 4 is a schematic configuration diagram of a control unit adopted in the DC-AC power converting apparatus according to the embodiment of the present invention; and

FIG. 5 is a diagram illustrating voltage waveform graphs of main components of the DC-AC power converting apparatus illustrated in FIG. 3.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

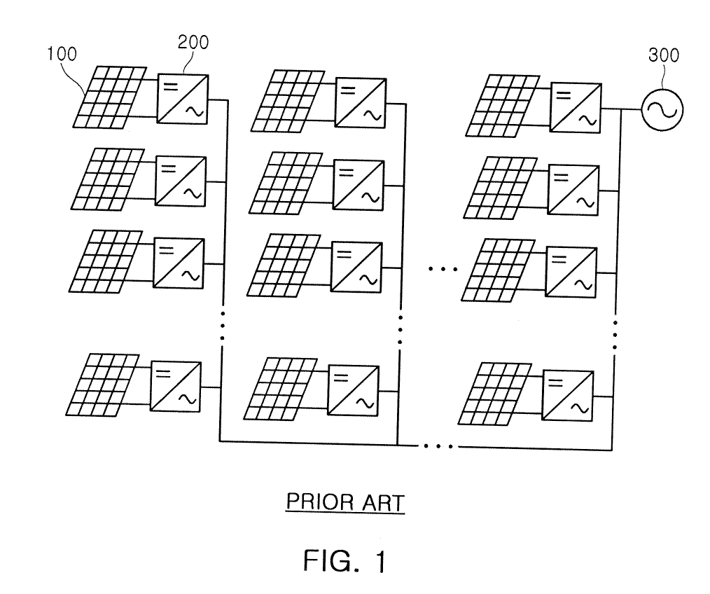

FIG. 1 is a schematic configuration diagram of a general solar power generation system.

Referring to FIG. 1, a general solar power system may include a photovoltaic cell 100 and a direct current (DC)-alternating current (AC) power converting apparatus 200.

The DC-AC power converting apparatus 200 may convert DC power from the photovoltaic cell 100 into AC power having a preset voltage level. The photovoltaic cell 100 and the DC-AC power converting apparatus 200 may be provided in plural, and the AC power transferred from the plurality of DC-AC power converting apparatuses 200 may be provided to a commercial power system 300 connected to the DC-AC power converting apparatuses 200.

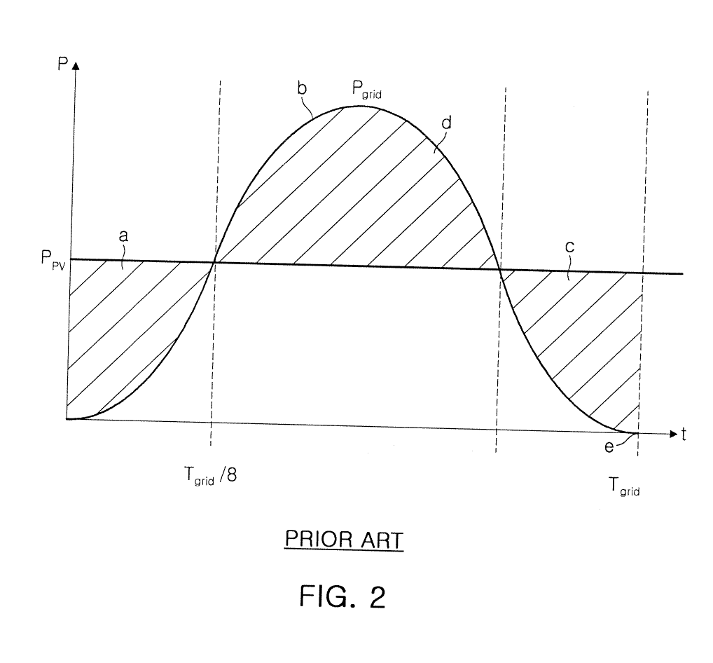

FIG. 2 is a waveform graph of output power and instantaneous system power of a photovoltaic cell.

Referring to FIG. 2, the output power of the photovoltaic cell may have power having a predetermined value denoted by letter “a” and the instantaneous system power thereof may have a waveform of an AC signal denoted by letter “b”.

The instantaneous system power has instantaneously changed values over one period e and power differences between input power and output power may be denoted by letters c and d.

That is, when the output power of the photovoltaic cell is higher than the instantaneous system power, surplus power corresponding to a difference between the output power and the instantaneous system power may be charged in an input capacitor of an input terminal, while when the output power of the photovoltaic cell is lower than the instantaneous system power, power transferred to the system is shortened by an amount equal to the difference and therefore, the power charged in the input capacitor may be discharged. The input capacitor may adopt a high-capacity electrolytic capacitor to charge and discharge sufficient power, which may lead to the increase in a circuit area and the lifespan decrease of a product.

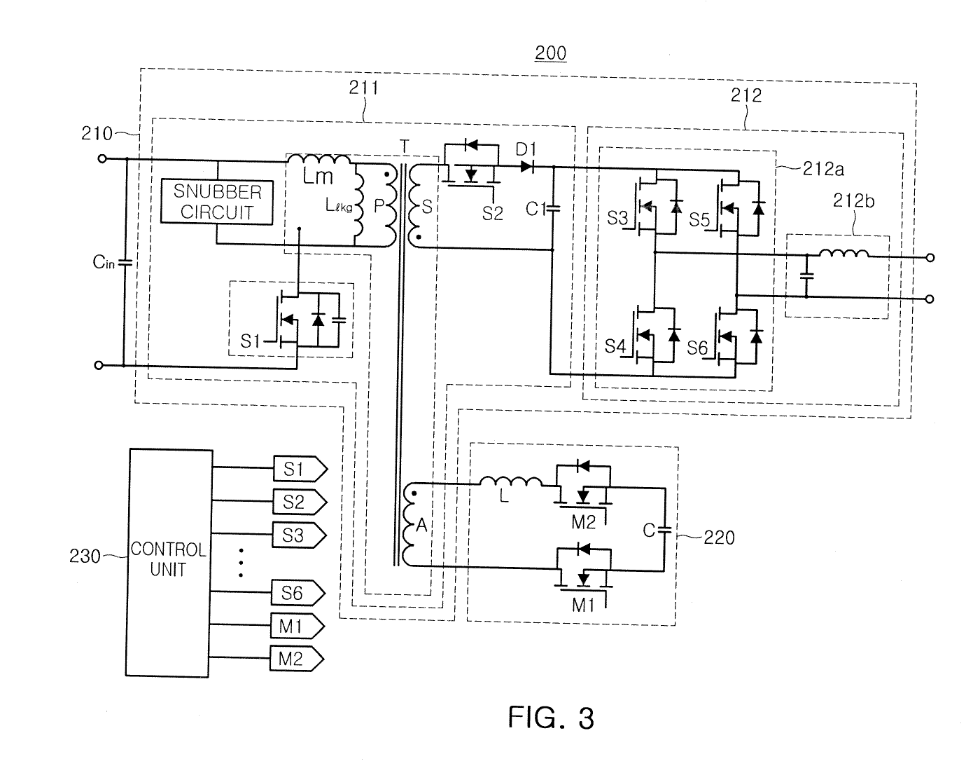

FIG. 3 is a schematic circuit diagram of a DC-AC power converting apparatus according to an embodiment of the present invention.

Referring to FIG. 3, the DC-AC power converting apparatus 200 according to the embodiment of the present invention may include a DC-AC power converting unit 210, a charging and discharging unit 220, and a control unit 230.

The DC-AC power converting unit 210 may include a converter 211 and an inverter 212.

The converter 211 may include: a switch S1 switching DC power from a photovoltaic cell; a transformer T including a primary winding P receiving the power switched by the switch S1, a secondary winding S forming a preset turns ratio with the primary winding and outputting power having a voltage level according to the preset turns ratio, and a tertiary winding receiving surplus power induced when a level of the DC power is higher than that of AC power, to transfer the induced surplus power to the charging and discharging unit 220, while receiving power discharged from the charging and discharging unit 220 when the level of the DC power is lower than that of the AC power; an output switch S2 switching the power output from the secondary winding S of the transformer T; an output diode D1 providing an output path for the power switched by the output switch S2; and an output capacitor C1 stabilizing the power from the output diode D1.

The transformer T may include magnetizing inductance Lm and leakage inductance Llkg.

In addition, the converter 211 may further include a snubber circuit consuming the surplus power generated during switching of a primary side.

The inverter 212 may include an inverter circuit 212a switching DC power from the converter 211 into AC power and a stabilization circuit 212b stabilizing the AC power converted from the inverter circuit 212a.

The DC power from the converter 211 may be first DC power having a predetermined voltage level and may be unfolding power having a form in which a sine wave signal is rectified. The power may be easily converted into AC power to allow for a reduction in capacity of the output capacitor C, such that a low-capacity capacitor may be employed to allow for reductions in manufacturing costs and a circuit area and a decrease in the lifespan of a corresponding product may be prevented.

The charging and discharging unit 220 may further include: a charging switch M1 providing a charging path for the surplus power generated by performing a switching operation when the level of the DC power from the photovoltaic cell 100 is higher than that of the AC power supplied to the system power; a discharging switch M2 providing a discharging path for the charged power by performing a switching operation when the level of the DC power from the photovoltaic cell 100 is lower than that of the AC power supplied to the system power; a capacitor C charging or discharging the power according to the switching operations of the charging and discharging switches M1 and M2; and an inductor L charging and discharging energy according to the switching operations of the charging and discharging switches M1 and M2.

The respective switching operations of the switches S1, S2, S3, S4, S5, S6, of the DC-AC power converting unit 210 for the converting, output path formation, and inverting operation and the charging and discharging switches M1, and M2 of the charging and discharging unit may be controlled by the control unit 230.

Therefore, the charging switch and the discharging switch M1 and M2 may be alternately switched on and switched off with respect to each other, and the charging and discharging unit 220 may be charged with the surplus power induced in the tertiary winding A of the transformer T or discharge the power to supplement low power, thereby compensating for ripple components generated in an input terminal thereof. Therefore, the capacity of an input capacitor Cᵢₙ is reduced, such that a film capacitor or a ceramic capacitor rather than the electrolytic capacitor may be adopted or input capacitor Cᵢₙ itself may not be adopted, thereby preventing the lifespan of the product from being reduced or reducing the manufacturing costs and the circuit area due to the use of the capacitor.

As illustrated in FIG. 1, the DC-AC power converting apparatus 200 according to the embodiment of the present invention as described above may be provided in plural in a module unit, and each of the plurality of DC-AC power converting apparatuses 200 may convert the DC power transferred from the plurality of photovoltaic cells 100 into the AC power to supply the AC power to the commercial power system 300 connected therewith.

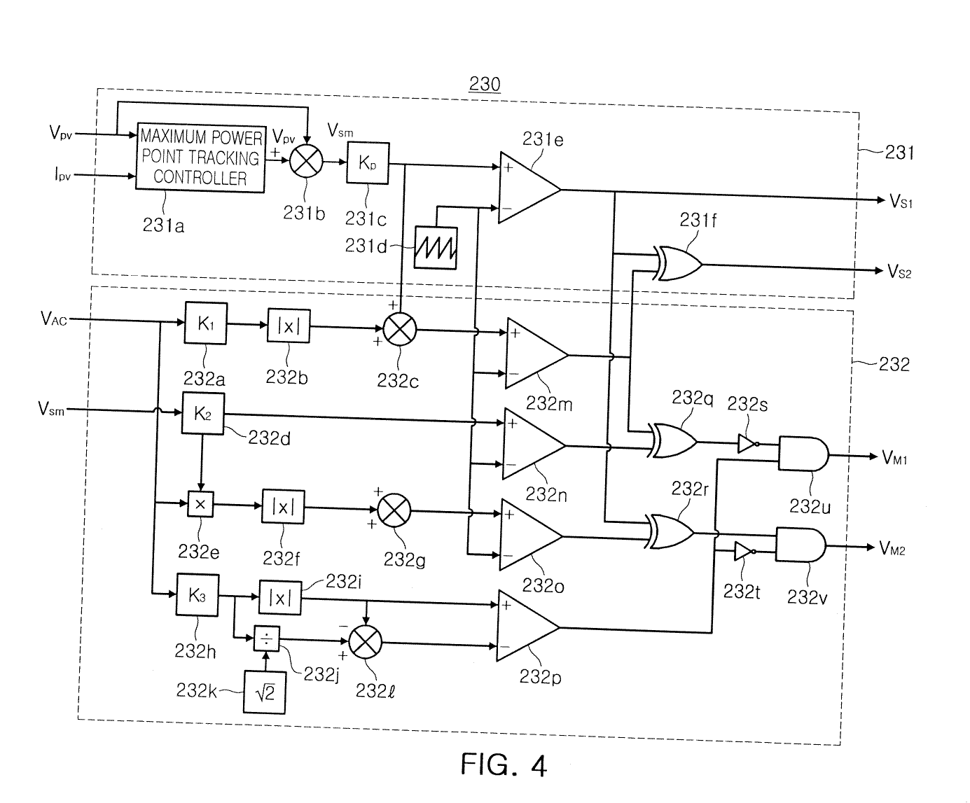

FIG. 4 is a schematic configuration diagram of a control unit adopted in the DC-AC power converting apparatus according to the embodiment of the present invention.

Referring to FIG. 3 and FIG. 4, the control unit 230 may include a converter control unit 231 and a charging and discharging control unit 232.

The converter control unit 231 may include a maximum power point tracking controller 231a, an operator 231b, a gain device 231c, a comparator 231e, and a logic operator 231f, and the maximum power point tracking controller 231a may track the maximum power point at which the DC power from the photovoltaic cell may maintain the maximum power, based on voltage information Vₚᵥ and current information Iₚᵥ regarding the DC power from the photovoltaic cell.

Output voltage Vₛₘ of the maximum power point tracking controller 231a is multiplied by a set gain value of the gain device 231c and is compared with a carrier from a reference signal generator 231d by the comparator 231e, whereby a power switching signal Vₛ₁ may be generated.

A duty of the power switching signal Vₛ₁ may be set by calculating a gain value based on the following Equation 1 and multiplying the output voltage Vₛₘ of the maximum power point tracking controller 231a by the calculated gain value. When the DC-AC converting apparatus 200 according to the embodiment of the present invention performs converting operations in a flyback manner, the DC-AC converting apparatus 200 needs to be operated in a discontinuous conduction mode, such that the magnetizing inductance Lm of the transformer T may be shown as in the following Equation 1.

$${L}_{m} < \frac{{T}_{s}}{{V}_{AC} {I}_{AC}} {( \frac{{V}_{AC} {V}_{in}}{{V}_{AC} + \sqrt{2} ( {N}_{s} / {N}_{p} ) {V}_{in}} )}^{2} \qquad [ Equation 1 ]$$

A duty D of the switch according to the magnetizing inductance Lm in the above Equation 1 may be shown in the following Equation 2.

$${D}_{sm , DCM} \leq \frac{\sqrt{4 {L}_{m} {V}_{g} {I}_{g} {f}_{s}}}{{V}_{pv}} \qquad [ Equation 2 ]$$

Command values of an output switching signal Vₛ₂ and charging and discharging switching signals V_{M1} and V_{M2} may be obtained through voltage information regarding the AC power applied to system voltage. To this end, the charging and discharging control unit 232 may includes a plurality of gain devices 232a, 232e, and 232h, a plurality of operators 232b, 232c, 232e, 232f, 232g, 232i, 232j, 232k, and 232l, a plurality of comparators 232m, 232n, 232o, and 232p, and a plurality of logic operators 232q, 232r, 232s, 232t, 232u, and 232v.

Voltage information VAC of the AC power is multiplied by preset gains K1, K2, and K3 to have absolute values, whereby the command values of the output switching signal Vₛ₂ and the charging and discharging switching signals V_{M1} and V_{M2} may be set.

The gain value K1 of the output switching signal Vₛ₂ may be obtained from the following Equation 4, which may be defined by the following Equation 3 provided to calculate a turn off time of a flyback converter. The value obtained from the following Equation 3 is a minimum value in a turn off period and the duty of the output switch S2 is higher than a value obtained from the following Equation 4.

$$\begin{matrix}{t}_{off} = \frac{{n}_{ps} {V}_{dc} {T}_{sm} {D}_{sm , pk}}{{V}_{ac , pk}} & [ Equation 3 ] \\ {D}_{sync} = \frac{n {V}_{dc} {D}_{sm}}{{V}_{ac , pk}} & [ Equation 4 ]\end{matrix}$$

The command values of the charging and discharging switching signals V_{M1} and V_{M2} that control the switching on/off of the charging and discharging switches of the charging and discharging unit 220 may be set by multiplying the maximum duty of the charging and discharging switching signals V_{M1} and V_{M2} by the output voltage Vₛₘ of the maximum power point tracking controller 231a and multiplying the multiplied value by the command value of the unfolding power.

Each command value and the carrier are compared by the comparators 232m, 232n, 232o, and 232p and output and the plurality of logic operators 232q, 232r, 232s, 232t, 232u, and 232v may form a signal synchronization circuit so that the power switching signal Vₛ₁ has a turn off level and then, the remaining output switching signal Vₛ₂ and the charging and discharging switching signals V_{M1} and V_{M2} have a turn on level.

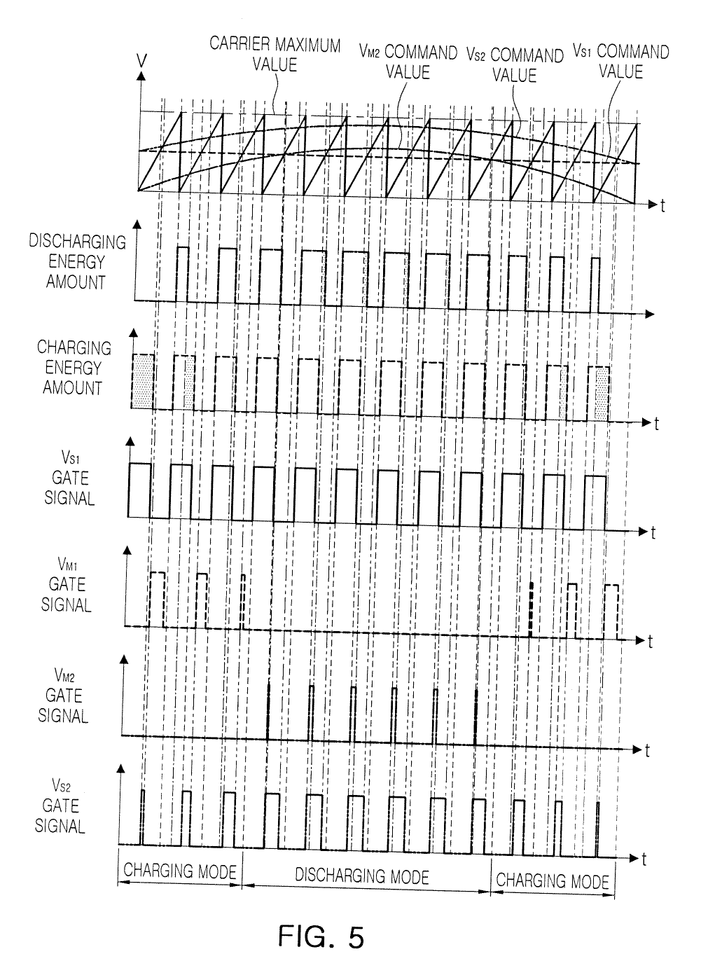

FIG. 5 illustrates voltage waveform graphs of main components of the DC-AC power converting apparatus according to the embodiment of the present invention illustrated in FIG. 3.

Referring to FIG. 5 along with FIGS. 3 and 4, the command value of the power switching signal Vₛ₁ is generated by multiplying the gain value Kₚ by the output voltage value V_{SM} of the maximum power point tracking controller 231a and may have a predetermined value as illustrated in a first waveform graph. The command value of the output switching signal Vₛ₂ has a form in which the command value of the power switching signal Vₛ₁ is added to the command value of the unfolding power and the maximum value thereof may be a value obtained from the above Equation 2.

The command value of the charging switching signal and the discharging switching signal V_{M1} and V_{M2} may be obtained from rectified system voltage information and may have a turn on level when the power switching signal Vs1 has a turn off level.

A second waveform graph and a third waveform graph respectively represent a discharging energy amount and a charging energy amount of the input capacitor Cᵢₙ by the charging and discharging switching signals V_{M1} and V_{M2} and a fourth waveform graph through a seventh waveform graph respectively represent the power switching signal, the charging switching signal, the discharging switching signal, and the output switching signal Vₛ₁, V_{M1}, V_{M2}, and Vₛ₂.

As set forth above, according to the embodiments of the present invention, a DC-AC power converting apparatus including no capacitor or a small capacity capacitor for removing a ripple in the input terminal thereof by charging surplus power or supplementing power shortage according to the difference between the output power and the instantaneous system power of the photovoltaic cell, thereby preventing the lifespan of the product from being reduced due to the adoption of an electrolytic capacitor.

While the present invention has been shown and described in connection with the embodiments, it will be apparent to those skilled in the art that modifications and variations can be made without departing from the spirit and scope of the invention as defined by the appended claims.

What is claimed is:

1. A direct current (DC)-alternating current (AC) power converting apparatus, comprising:
a DC-AC power converting unit converting DC power into AC power; and
a charging and discharging unit charging surplus power induced when a level of the DC power is higher than that of the AC power and discharging the charged power when the level of the DC power is lower than that of the AC power.

2. The DC-AC power converting apparatus of claim 1, wherein the charging and discharging unit includes:
a charging switch performing a switching operation to provide a charging path for the induced surplus power, when the level of the DC power is higher than that of the AC power;
a discharging switch performing a switching operation to provide a discharging path for the charged power, when the level of the DC power is lower than that of the AC power; and
a capacitor unit charging or discharging power according to the switching operations of the charging switch and the discharging switch.

3. The DC-AC power converting apparatus of claim 2, wherein the charging switch and the discharging switch are alternately switched on and switched off with respect to each other.

4. The DC-AC power converting apparatus of claim 2, wherein the charging and discharging unit further includes:
an inductor unit LC resonating with the capacitor unit to provide a soft switching operation of the charging switch and the discharging switch.

5. The DC-AC power converting apparatus of claim 1, wherein the DC-AC power converting unit includes:
a converter switching the DC power to convert the DC power into first DC power having a preset frequency; and
an inverter switching the first DC power to convert the first DC power into the AC power.

6. The DC-AC power converting apparatus of claim 5, wherein the converter includes:
a switch switching the DC power;
a transformer including a primary winding receiving the power switched by the switch, a secondary winding forming a preset turns ratio with the primary winding and outputting power having a voltage level according to the preset turns ratio, and a tertiary winding receiving the surplus power induced when the level of the DC power is higher than that of AC power, to transfer the induced surplus power to the charging and discharging unit, while receiving the power discharged from the charging and discharging unit when the level of the DC power is lower than that of the AC power;
an output switch switching the power output from the secondary winding of the transformer;
an output diode providing an output path for the power switched by the output switch; and
an output capacitor stabilizing the power from the output diode.

7. The DC-AC power converting apparatus of claim 5, wherein the inverter includes:
an inverter circuit switching the first DC power to convert the first DC power into the AC power; and
a stabilization circuit stabilizing the converted AC power from the inverter circuit.

8. The DC-AC power converting apparatus of claim 1, further comprising an input capacitor reducing a ripple in an input terminal generated due to a variation in the AC power.

9. The DC-AC power converting apparatus of claim 6, wherein the first DC power is unfolding power having a form in which a sine wave signal is rectified.

10. The DC-AC power converting apparatus of claim 6, further comprising a control unit controlling power switching of the DC-AC power converting unit and charging and discharging switching of the charging and discharging unit.

11. The DC-AC power converting apparatus of claim 10, wherein the control unit includes:
a converter control unit providing a power switching signal having a duty set according to a comparison between voltage of a maximum power point based on voltage and current information regarding the DC power and a preset carrier and an output switching signal having a duty set according to the AC power; and
a charging and discharging control unit providing a charging and discharging switching signal having a duty set according to the voltage information of the maximum power point.

12. The DC-AC power converting apparatus of claim 11, wherein the converter control unit generates the power switching signal by multiplying a preset first gain by the voltage of the maximum power point, and generates the output switching signal by adding the first DC power to the power switching signal.

13. The DC-AC power converting apparatus of claim 11, wherein when the power switching signal has a turn off level, the charging and discharging switching signal has a turn on level.

14. A solar power supplying apparatus, comprising:
a photovoltaic cell collecting solar light to convert the light into DC power;
a DC-AC power converting unit converting the DC power from the photovoltaic cell into AC power; and
a charging and discharging unit charging surplus power induced when a level of the DC power is higher than that of the AC power and discharging the charged power when the level of the DC power is lower than that of the AC power.

15. The solar power supplying apparatus of claim 14, wherein the charging and discharging unit includes:
a charging switch performing a switching operation to provide a charging path for the induced surplus power, when the level of the DC power is higher than that of the AC power;
a discharging switch performing a switching operation to provide a discharging path for the charged power, when the level of the DC power is lower than that of the AC power; and
a capacitor unit charging or discharging power according to the switching operations of the charging switch and the discharging switch.

16. The solar power supplying apparatus of claim 15, wherein the charging switch and the discharging switch are alternately switched on and switched off with respect to each other.

17. The solar power supplying apparatus of claim 15, wherein the charging and discharging unit includes:
an inductor unit LC resonating with the capacitor unit to provide a soft switching operation of the charging switch and the discharging switch.

18. The solar power supplying apparatus of claim 14, wherein the DC-AC power converting unit includes:
a converter switching the DC power to convert the DC power into first DC power having a preset frequency; and
an inverter switching the first DC power to convert the first DC power into the AC power.

19. The solar power supplying apparatus of claim 18, wherein the converter includes:
a switch switching the DC power;
a transformer including a primary winding receiving the power switched by the switch, a secondary winding forming a preset turns ratio with the primary winding and outputting power having a voltage level according to the preset turns ratio, and a tertiary winding receiving the surplus power induced when the level of the DC power is higher than that of AC power, to transfer the induced surplus power to the charging and discharging unit, while receiving the power discharged from the charging and discharging unit when the level of the DC power is lower than that of the AC power;
an output switch switching the power output from the secondary winding of the transformer;
an output diode providing an output path for the power switched by the output switch; and
an output capacitor stabilizing the power from the output diode.

20. The solar power supplying apparatus of claim 18, wherein the inverter includes:
an inverter circuit switching the first DC power to convert the first DC power into the AC power; and
a stabilization circuit stabilizing the converted AC power from the inverter circuit.

21. The solar power supplying apparatus of claim 14, further comprising an input capacitor reducing a ripple in an input terminal generated due to a variation in the AC power.

22. The solar power supplying apparatus of claim 19, wherein the first DC power is unfolding power having a form in which a sine wave signal is rectified.

23. The solar power supplying apparatus of claim 19, further comprising a control unit controlling power switching of the DC-AC power converting unit and charging and discharging switching of the charging and discharging unit.

24. The solar power supplying apparatus of claim 23, wherein the control unit includes:
a converter control unit providing a power switching signal having a duty set according to a comparison between voltage of a maximum power point based on voltage and current information regarding the DC power and a preset carrier and an output switching signal having a duty set according to the AC power; and
a charging and discharging control unit providing a charging and discharging switching signal having a duty set according to the voltage information of the maximum power point.

25. The solar power supplying apparatus of claim 24, wherein the converter control unit generates the power switching signal by multiplying a preset first gain by the voltage of the maximum power point, and generates the output switching signal by adding the first DC power to the power switching signal.

26. The solar power supplying apparatus of claim 24, wherein when the power switching signal has a turn off level, the charging and discharging switching signal has a turn on level.
